(19) United States
(12) Patent Application Publication
(10) Pub. No.: US 2022/0395990 A1
(43) Pub. Date: Dec. 15, 2022

(54) SAFE BOX CUTTER

(71) Applicant: INDUSTRO INTERNATIONAL CO., LTD., Taichung City (TW)

(72) Inventor: KUO-CHAN HUANG, Taichung (TW)

(21) Appl. No.: 17/347,607

(22) Filed: Jun. 15, 2021

(51) Int. Cl. B26B 5/00

(52) U.S. Cl. CPC B26B 5/003; B26B 5/005

(57) ABSTRACT

A box cutter includes a blade, a handle, a sheath and a restraining element. The handle includes a space for receiving a rear portion of the blade, a chamber in communication with the space, a rear slot in communication with the space, and a front slot in communication with the chamber. The sheath is movable in the chamber and covers a front portion of the blade. The restraining element is movable in the handle between a locking position and an unlocking position. In the locking position, the restraining element abuts against the sheath to prevent the sheath from retreating into the handle to keep on covering the front portion of the blade. In the unlocking position, the restraining element is moved from the sheath to allow the sheath to retreat into the handle to allow the front portion of the blade to extend from the sheath.

### BACKGROUND OF INVENTION

### 1. Field of Invention

The present invention relates to a box cutter and, more particularly, to a safe box cutter.

### 2. Related Prior Art

A typical box cutter (or “utility knife”) includes a blade, a holder and a handle. The handle includes a rectilinear groove extending to a front slot from a rear slot. A gap is inserted in the groove. The holder includes a hook and a stem. The holder is inserted in the groove via the rear slot of the handle. The holder is movable along the gap. The hook hooks the blade. The stem is connected to a button that is located out of the handle. The button is operable to move the holder along the gap, thereby moving a front end of the blade from or into the handle. The use of the box cutter is not without any problem. The button could be operated to extend the front end of the blade from the handle by accident. In such a case, a person might be cut by the blade.

The present invention is therefore intended to obviate or at least alleviate the problems encountered in the prior art.

### SUMMARY OF INVENTION

It is the primary objective of the present invention to provide a safe box cutter.

To achieve the foregoing objective, the box cutter includes a blade, a handle, a sheath and a restraining element. The handle includes a space for receiving a rear portion of the blade, a chamber in communication with the space, a rear slot in communication with the space, and a front slot in communication with the chamber. The sheath is movable in the chamber and covers a front portion of the blade. The restraining element is movable in the handle between a locking position and an unlocking position. In the locking position, the restraining element abuts against the sheath to prevent the sheath from retreating into the handle to keep on covering the front portion of the blade. In the unlocking position, the restraining element is moved from the sheath to allow the sheath to retreat into the handle to allow the front portion of the blade to extend from the sheath.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a safe box cutter according to the preferred embodiment of the present invention;

FIG. 2 is an exploded view of the safe box cutter shown in FIG. 1;

FIG. 3 is a perspective view of a blade and a holder of the safe box cutter shown in FIG. 1;

FIG. 4 is a cross-sectional view of the box cutter taken along a line A-A shown in FIG. 1;

FIG. 5 is a perspective view of a handle of the safe box cutter shown in FIG. 1;

FIG. 6 is a cross-sectional view of the box cutter taken along a line B-B shown in FIG. 5;

FIG. 7 is a cross-sectional view of the box cutter taken along a line C-C shown in FIG. 5;

FIG. 8 is a cross-sectional view of the handle shown in FIG. 5;

FIG. 9 is a cross-sectional view of the handle taken along a line D-D shown in FIG. 8;

FIG. 10 is a perspective view of a sheath and a spring of the safe box cutter shown in FIG. 1;

FIG. 11 is a perspective view of a front portion of a shell of the safe box cutter shown in FIG. 1;

FIG. 12 is a cut-away view of the safe box cutter shown in FIG. 1;

FIG. 13 is a perspective view of the safe box cutter shown in FIG. 1, with another shell removed;

FIG. 14 is a perspective view of the safe box cutter in another position than shown in FIG. 13;

FIG. 15 is a side view of a front portion of the safe box cutter shown in FIG. 1; and

FIG. 16 is a side view of the front portion of the safe box cutter in another position than shown in FIG. 15.

### DETAILED DESCRIPTION OF PREFERRED EMBODIMENT

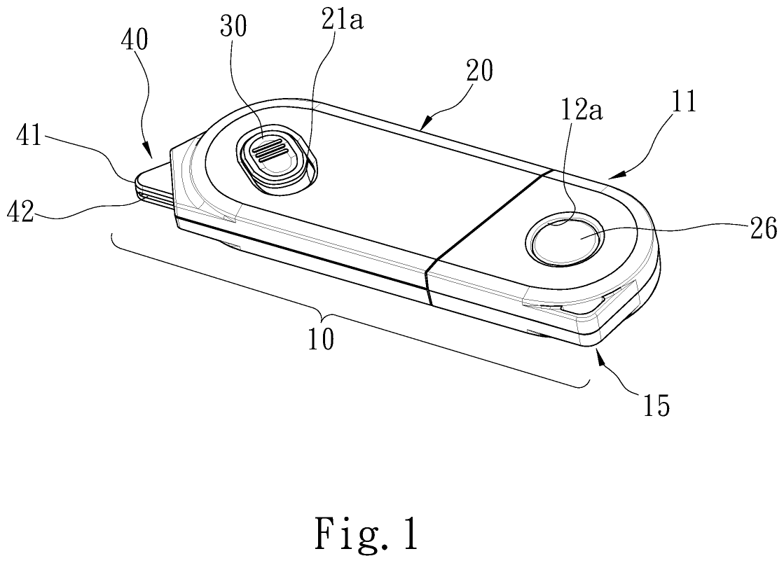

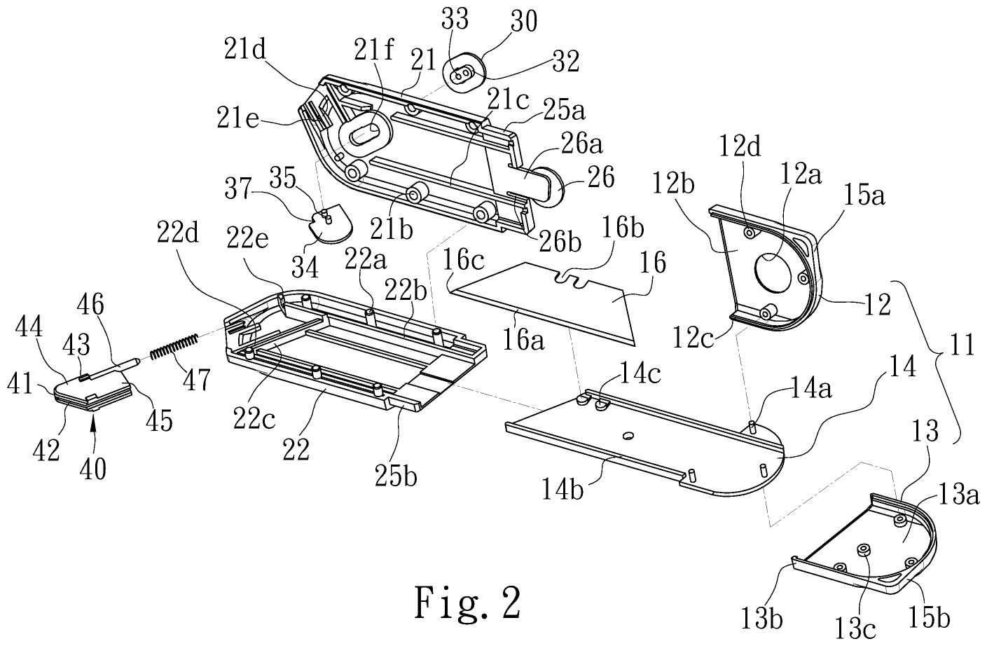

Referring to FIGS. 1 and 2, a box cutter 10 includes a blade 16, a holder 11, a handle 20, a switch 30, a restraining element 34, a sheath 40 and a spring 47 according to the preferred embodiment of the present invention. The blade 16 includes a cutting edge 16a, two cutouts 16b and two tips 16c. The cutouts 16b are made in an edge opposite to the cutting edge 16a. The tips 16c are formed at two ends of the cutting edge 16a.

The holder 11 includes a lug 15 to which a loop (not shown) can be tied. Such a loop is used to facilitate carrying of the box cutter 10.

The blade 16 is substantially supported on the holder 11. The handle 20 includes a lock 26 for elastically locking the holder 11 to the handle 20. Thus, the blade 16 is kept in the handle 20 except for a front one of the tips 16c.

The sheath 40 is movably located in the handle 20 so that a front end 41 of the sheath 40 is movable into and from the handle 20. The sheath 40 covers the blade 16. The restraining element 34 is movable in the handle 20. The switch 30 is movable on the handle 20. The switch 30 is connected to the restraining element 34. The switch 30 is operable to move the restraining element 34 between a locking position and an unlocking position. In the locking position, the restraining element 34 keeps the sheath 40 in position relative to the handle 20 so that the front lower portion of the sheath 40 continues to cover the front tip 16C. In the unlocking position, the restraining element 34 allows the sheath 40 to retreat into the handle 20, thereby causing the front lower portion of the sheath 40 to expose the tip 16c.

The holder 11 includes two shells 12 and 13 and a plate 14. The plate 14 is T-shaped. That is, the plate 14 includes a first portion wider than a second portion. Several stems 14a extend from one of two sides of the first portion of the plate 14. Several stems 14d extend from the remaining one of the sides of the first portion of the plate 14. The second portion of the plate 14 supports the blade 16. Two ribs 14b and two bosses 14c extends on one of the sides of the second portion of the plate 14.

The shell 12 includes a rim 12c extending along an edge of a wall 12b. The wall 12b is formed with an aperture 12a for receiving the lock 26. Several sockets 12d are formed on a side of the wall 12b. The shell 12 is further formed with an arched portion 15a in the vicinity of the rim 12c.

The profile of the shell 13 like the profile of the shell 12. The shell 13 includes a rim 13b extending along an edge of a wall 13a. Several sockets 13c are formed on a side of the wall 13a. The shell 13 is further formed with an arched portion 15b in the vicinity of the rim 13b.

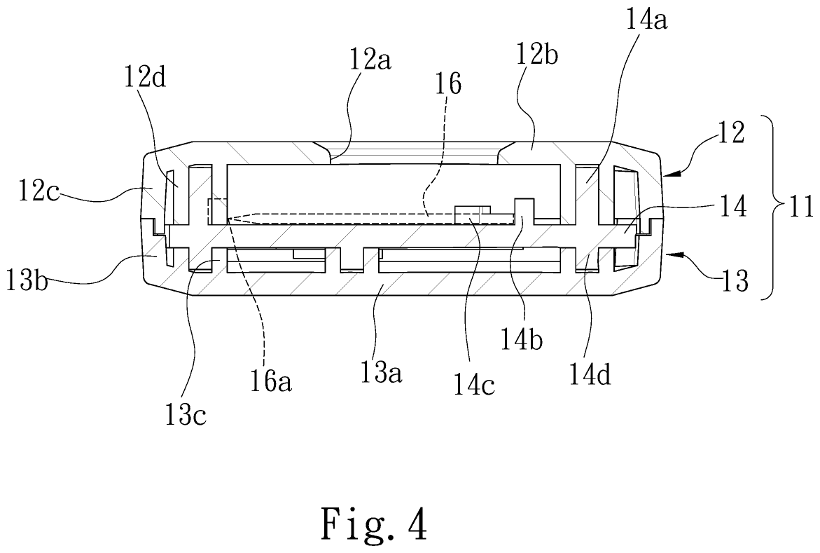

Referring to FIGS. 2 through 4, the shells 12 and 13 are connected to the opposite sides of the first portion of the plate 14. To this end, the stems 14a extending from one of the sides of the first portion of the plate 14 are fitted in the sockets 12d so that the plate 14 is connected to the shell 12. In addition, the stems 14d formed on the remaining one of the first portion of the plate 14 are fitted in the sockets 13c of the shell 13 so that the plate 14 is connected to the shell 13. The rim 12c abuts against the rim 13b. The walls 12b and 13a are located two the sides of the plate 14. Now, the arched portion 15a of the shell 12 and the arched portion 15b of the shell 13 together form the lug 15.

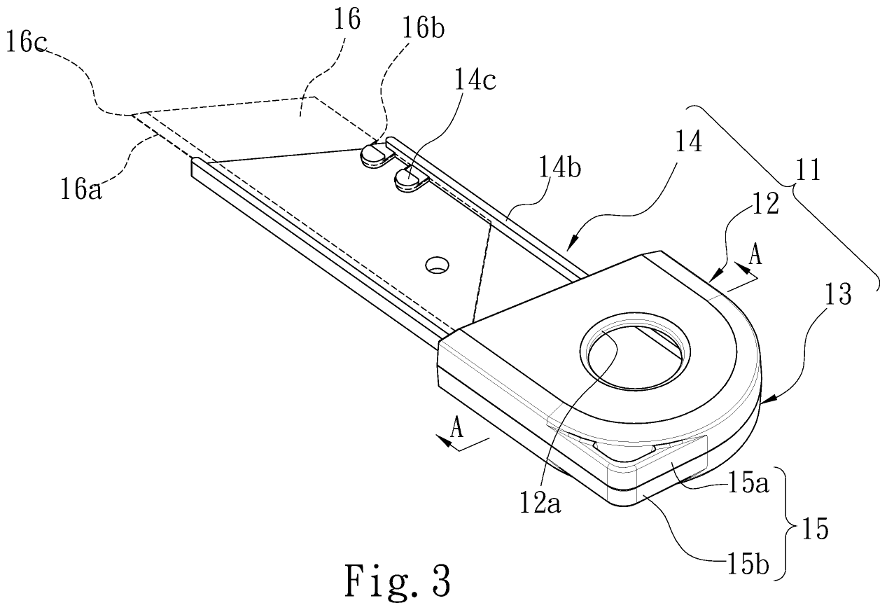

Referring to FIG. 3, the second portion of the plate 14 supports the blade 16, except for the front tip 16c. The bosses 14c are inserted in the cutouts 16b so that the blade 16 is not movable relative to the plate 14 along a length of the plate 14.

Referring to FIG. 2, the handle 20 includes two interconnected shells 21 and 22. There are several sockets 21b arranged along an edge of the shell 21. Two ribs 21c are formed on a side of the shell 21, parallel to each other. Two pairs of ribs 21d are formed on the side of the shell 21. The pairs of ribs 21d extend parallel to each other. In each of the pairs, the ribs 21d extend parallel to each other, separated by a groove 21e. An extension 25a extends from a rear end of the shell 21. The ribs 21c extend to the extension 25a. An elastic leaf 26a extends from the extension 25a. The extension 25a includes two cracks 26b on two opposite sides of the elastic leaf 26a extends. The elastic leaf 26a and the lock 26 are made in one piece. The shell 21 is formed with a lateral slot 21f in communication with a cavity 21a made in another side (FIG. 1). The combination of the cavity 21a with the lateral slot 21f is like a countersink hole.

The shell 22 is formed with several stems 22a along an edge. The stems 22a are shaped in compliance with the sockets 21b. A side of the shell 22 is formed two ribs 22b extending parallel to each other. Two pairs of ribs 22c extend on the side of the shell 22. The pairs of ribs 22c extend parallel to each other. In each of the pairs, the ribs 22c extend parallel to each other, separated by a groove 22d. An extension 25b extends from a rear end of the shell 22. The ribs 22b extend to the extension 25b. There is made an orifice 22e in a front portion of one of the ribs 22b.

The switch 30 includes a connective portion 32 formed on a side. Two bores 33 are made in the connective portion 32 of the switch 30. The restraining element 34 includes two stems 35 formed on a side, corresponding to the bores 33. A portion of an edge of the restraining element 34 is used as a stop 37.

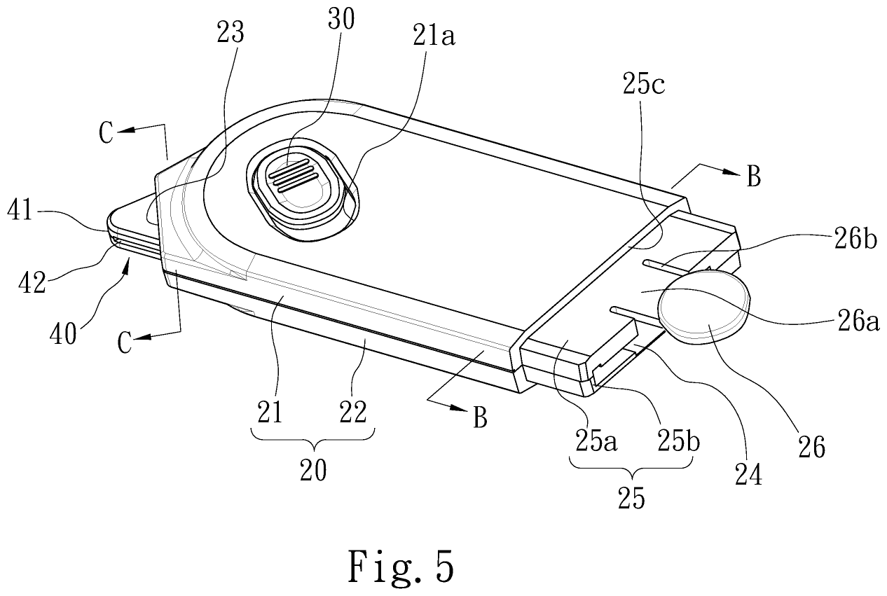

Referring to FIG. 5, the shells 21 and 22 are interconnected, thereby forming the handle 20. The handle 20 includes a front slot 23 and a rear slot 24. The rear slot 24 is made in a rear end of the insert 25, which consists of the extensions 25a and 25b. The width of the insert 25 is smaller than the width of the remaining portion of the shell 21 so that there is a shoulder 25c between the insert 25 and the remaining portion of the shell 21.

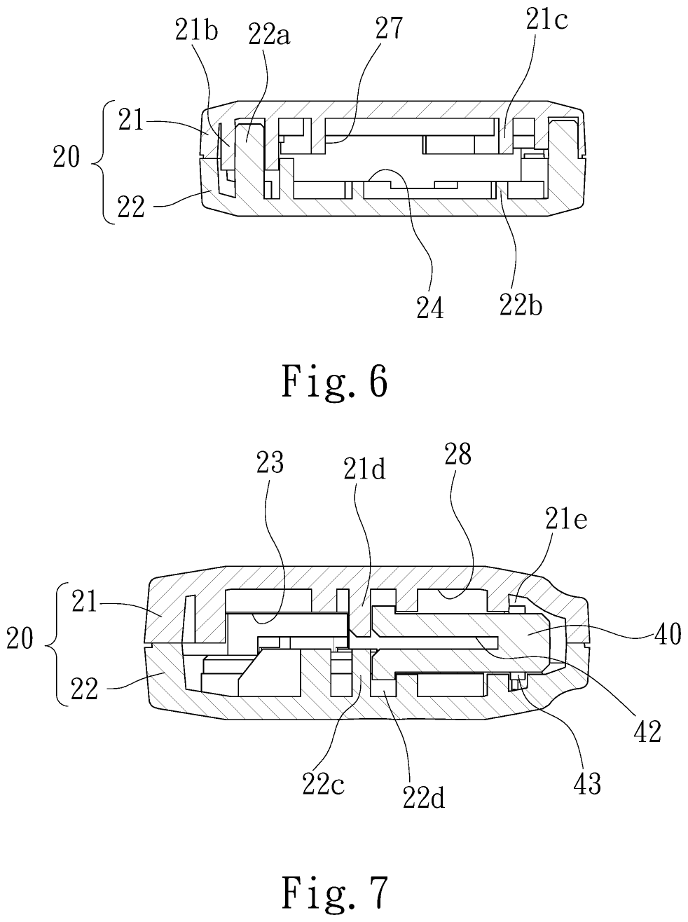

Referring to FIG. 6, the stems 22a are fitted in the sockets 21b to interconnect the shells 21 and 22. Glue or the like can be used to enhance the interconnection of the shells 21 and 22. Each of the ribs 21c abuts against a corresponding one of the ribs 22b to providing a space 27 in communication with the rear slot 24.

Referring to FIG. 7, each of the pairs of ribs 21d abuts against a corresponding one of the pairs of ribs 22c to provide a chamber 28 in communication with the front slot 23. The chamber 28 is in communication with the space 27. Each of the grooves 21e is aligned with a corresponding one of the grooves 22d.

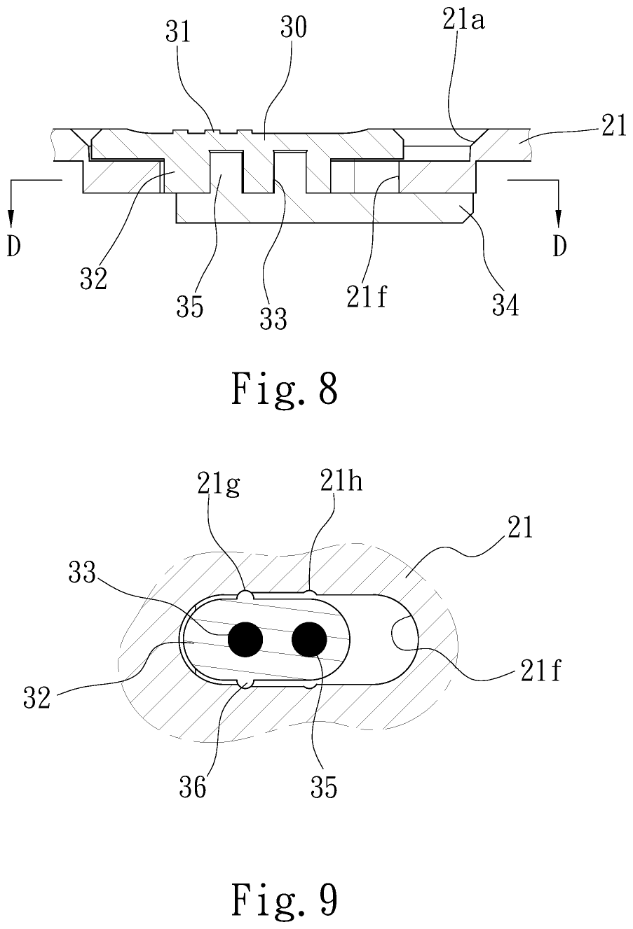

Referring to FIGS. 2, 5, 7 and 8, the switch 30 is inserted in the cavity 21a. The connective portion 32 of the switch 30 extends into the space 27 from the cavity 21a via the lateral slot 21f The stems 35 are fitted in the bores 33 to connect the restraining element 34 to the switch 30. Glue or the like can be used to enhance the interconnection of the restraining element 34 and the switch 30. Thus, the switch 30 is kept on the handle 20 and the restraining element 34 is kept in the handle 20.

The switch 30 is movable in the cavity 21a. The connective portion 32 of the switch 30 is movable in the lateral slot 21f The restraining element 34 is movable in the space 27. A skid-proof pattern 31 is formed on an opposite side of the switch 30. The skid-proof pattern 31 is used to contact a user's finger to facilitate the movement of the switch 30.

Referring to FIG. 9, an edge of the lateral slot 21f includes two front recesses 21g and two rear recesses 21h. The connective portion 32 of the switch 30 includes two opposite bosses 36. The bosses 36 are inserted in the front recesses 21g when the restraining element 34 is in the locking position. The bosses 36 are inserted in the rear recesses 21h when the restraining element 34 is in the unlocking position.

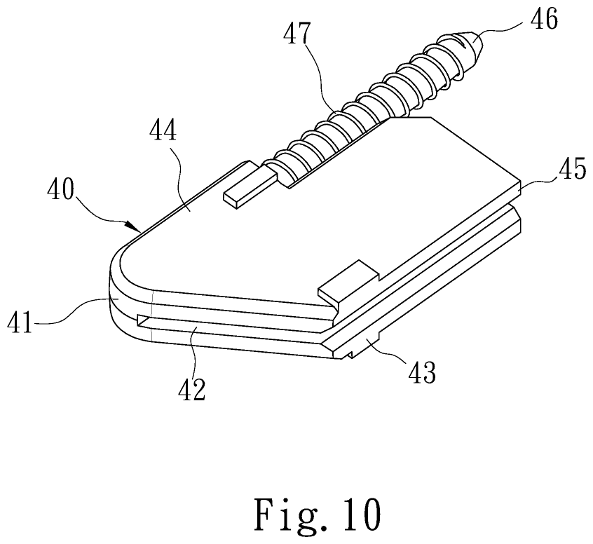

Referring to FIG. 10, the sheath 40 includes a front end 41, two flanks 45 extending parallel to each other, an intermediate portion 44 formed between the flanks 45, a gap 42 extending between the flanks 45, and a rod 46 extending from the intermediate portion 44 opposite to the front end 41. Two fins 43 extend from a side of each of the flanks 45. The fins 43 of each of the flanks 45 extend parallel to each other. A spring is supported on the rod 46.

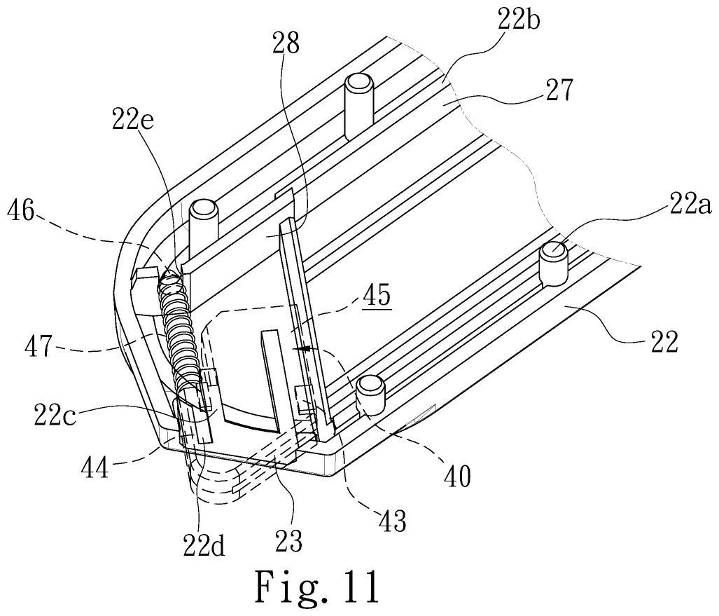

Referring to FIG. 11, from which the shell 21 is moved, the space 27 is in communication with the chamber 28. The sheath 40 is movable in the chamber 28. The rod 46 extends in the orifice 22e so that the spring 47 is compressed between the intermediate portion 44 of the sheath 40 and the corresponding rib 22b. Thus, the spring 47 biases the sheath 40 from the corresponding rib 22b so that the front end 41 of the sheath 40 extends from the handle 20 via the front slot 23. The width of the sheath 40 is larger than the width of the front slot 23 so that the sheath 40 is retained in the handle 20 except for the front end 41 of the intermediate portion 44 of the sheath 40.

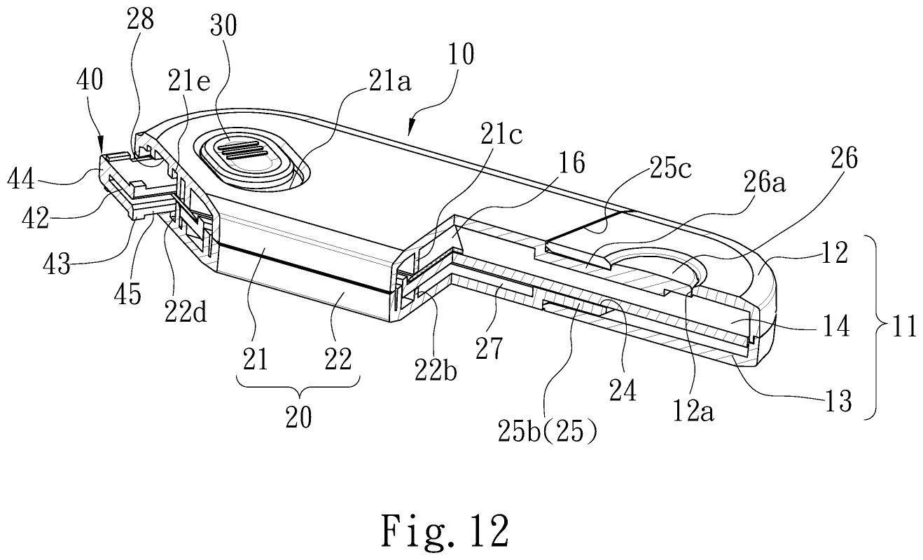

Referring to FIGS. 7 and 12, the fins 43 on one of the flanks 45 are movably inserted in the grooves 21e. The fins 43 on the remaining one of the flanks 45 are movably inserted in the grooves 22d. Thus, the movement of the sheath 40 relative to the handle 20 is rendered smooth.

Referring to FIG. 12, the plate 14 of the holder 11 is inserted in the space 27 of the handle 20 via the rear slot 24. A front portion of the blade 16 is inserted in the gap 42 of the sheath 40. The shell 12 presses the lock 26, thereby deforming the elastic leaf 26a and inserting the insert 25 in the gap between the shells 12 and 13. The elastic leaf 26a recovers and hence snaps the lock 26 into the aperture 12a when the shoulder 25c reaches the shells 12 and 13. The aperture 12a receives the lock 26 to lock the holder 11 to the handle 20. Accordingly, the plate 14 is retained in the space 27 of the handle 20, and so is the blade 16. The holder 11 is not translatable or rotatable relative to the handle 20.

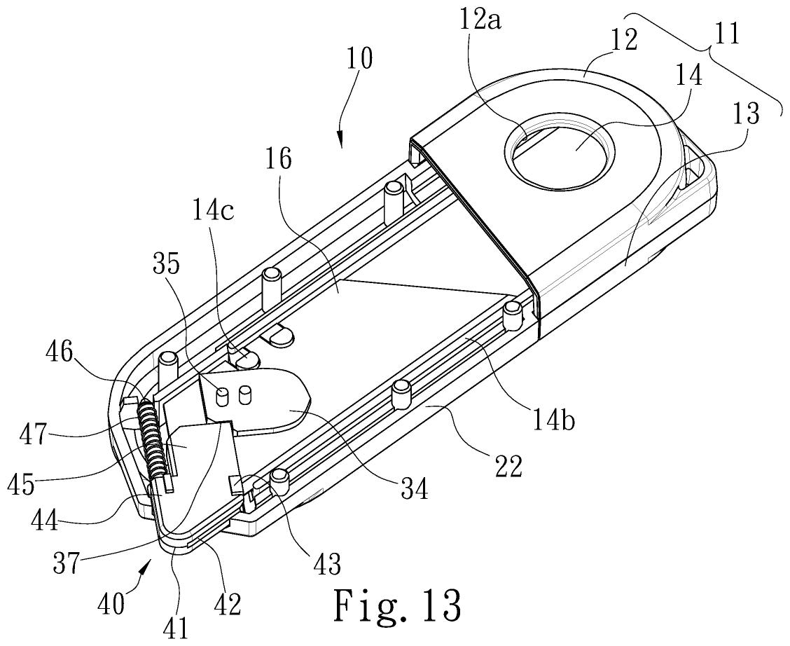

Referring to FIGS. 12 and 13, when the box cutter 10 is not in use, the spring 47 biases the sheath 40 to extend the front end 41 of the sheath 40 from the handle 20. The front end 41 of the sheath 40 covers the front tip 16c and a front portion of the cutting edge 16a.

The restraining element 34 is in the locking position. The stop 37 abuts against the flanks 45 of the sheath 40. Thus, the restraining element 34 prevents the front end 41 of the sheath 40 from retreating into the handle 20. That is, the front end 41 of the sheath 40 keeps on covering the front tip 16c and the front portion of the cutting edge 16a.

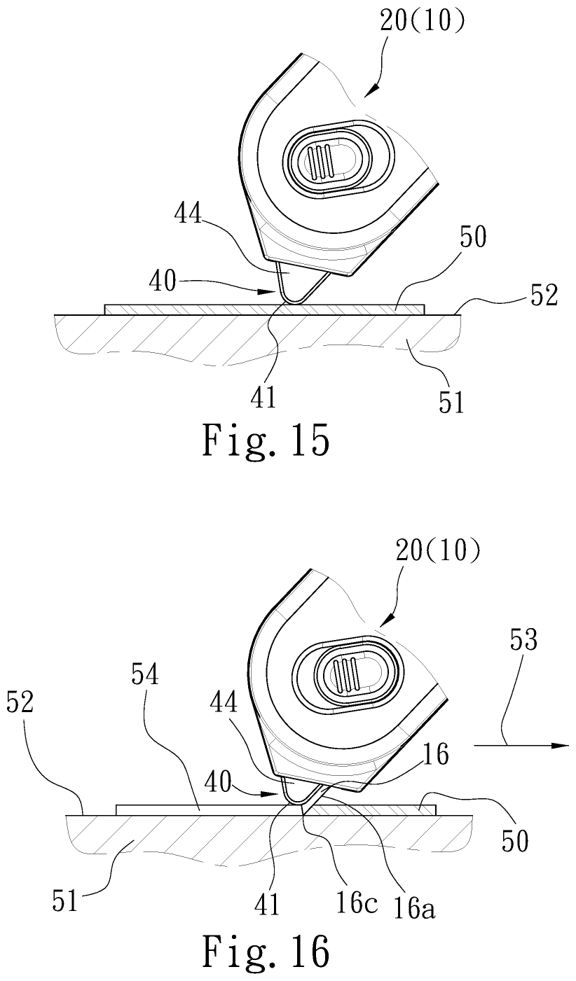

Referring to FIG. 15, the front end 41 of the sheath 40 is pressed against a workpiece 50 supported on a face 52 of a supporting element 51 such as a table. As the restraining element 34 is in the locking position where the stop 37 abuts against the flanks 45 of the sheath 40, the front end 41 of the sheath 40 cannot retreat into the handle 20. Hence, the front tip 16c or a front portion of the cutting edge 16a cannot extend from the front end 41 of the sheath 40 and hence cannot cut the workpiece 50 or a person.

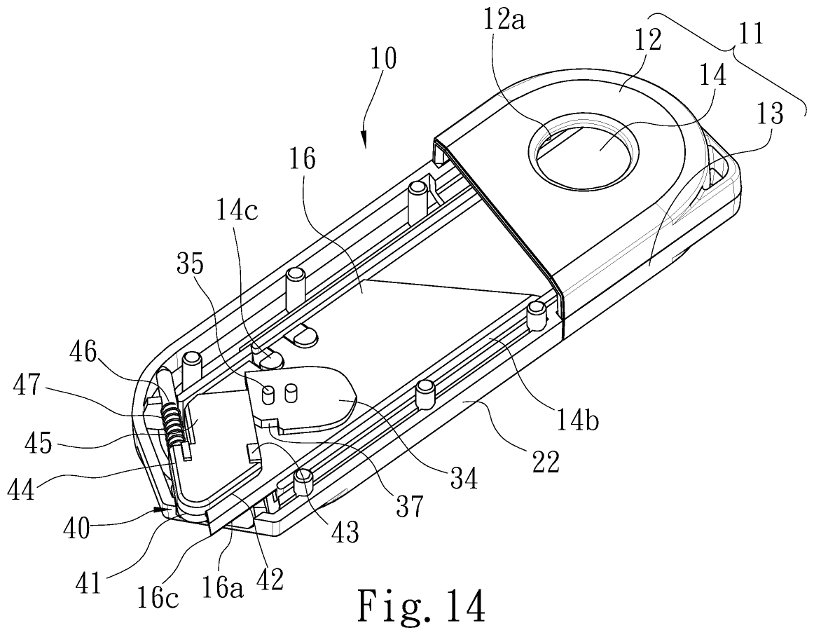

Referring to FIGS. 12 and 14, the restraining element 34 is in the unlocking position. The stop 37 is moved from the flanks 45 of the sheath 40. The front end 41 of the intermediate portion 44 of the sheath 40 is allowed to retreat into the chamber 28, past the restraining element 34. Thus, the front end 41 of the sheath 40 is allowed to expose the front tip 16c and the front portion of the cutting edge 16a.

Referring to FIG. 16, the front end 41 of the sheath 40 is pressed against the workpiece 50 supported on the face 52 of the supporting element 51. As the restraining element 34 is in the unlocking position where the stop 37 is moved from the flanks 45 of the sheath 40, the front end 41 of the intermediate portion 44 of the sheath 40 is allowed to retreat into the chamber 28, past the restraining element 34. Thus, the sheath 40 is allowed to expose the front tip 16c and the front portion of the cutting edge 16a which cut into the workpiece 50. The front tip 16c and the front portion of the cutting edge 16 cut a slit 54 in the workpiece 50 as the box cutter 10 is moved in a sense of direction indicated with an arrow head 53.

The spring 47 is compressed between the intermediate portion 44 of the sheath 40 and the corresponding rib 22b. Once the box cutter 10 is moved from the workpiece 50, the spring 47 biases the sheath 40 so that the front end 41 of the sheath 40 extends from the handle 20. The front end 41 of the sheath 40 covers the front tip 16c and a front portion of the cutting edge 16a.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A box cutter comprising:
a blade comprising a front portion and a rear portion;
a handle comprising a space for receiving the rear portion of the blade, a chamber in communication with the space, a rear slot in communication with the space, and a front slot in communication with the chamber;
a sheath movable in the chamber, wherein the sheath covers the front portion of the blade;
a restraining element movable in the handle between a locking position and an unlocking position, wherein in the locking position, the restraining element abuts against the sheath to prevent the sheath from retreating into the handle to keep on covering the front portion of the blade, wherein in the unlocking position, the restraining element is moved from the sheath to allow the sheath to retreat into the handle to allow the front portion of the blade to extend from the sheath.

2. The box cutter according to claim 1, wherein the sheath comprises two pair of fins, wherein the handle comprises two pairs of grooves for receiving the pairs of fins.

3. The box cutter according to claim 1, comprising a spring between a portion of the handle and the intermediate portion of the sheath to bias the sheath from the chamber.

4. The box cutter according to claim 3, wherein the sheath comprises a rod inserted in the spring.

5. The box cutter according to claim 1, wherein the sheath comprises:
two flanks;
the gap extending between the flanks to receive the front portion of the blade; and
an intermediate portion formed between the flanks.

6. The box cutter according to claim 1, comprising a holder for receiving the rear portion of the blade, wherein the handle comprises an insert inserted in the holder.

7. The box cutter according to claim 6, wherein the rear slot is made in the insert, wherein the holder comprises a plate extending in the space via the rear slot.

8. The box cutter according to claim 6, wherein the insert comprises:
an elastic leaf extending from a rear end of the insert; and
a lock formed at a rear end of the elastic leaf, and
the holder comprising an aperture for receiving the lock.

9. The box cutter according to claim 1, comprising a switch movable on the handle and comprising a connective portion connected to the restraining element, wherein the handle comprises a lateral slot in which the connective portion of the switch is movable.

10. The box cutter according to claim 9, wherein the handle comprises a cavity in communication with the lateral slot, wherein the switch is movable in the cavity.

11. The box cutter according to claim 9, the handle comprises at least one front recess and rear recess in an edge of the slot, wherein the connective portion of the switch comprises at least one boss inserted in the front recess as the restraining element is in the locking position, the boss is inserted in the rear recess as the restraining element is in the unlocking position.

12. The box cutter according to claim 8, wherein the switch is formed with a skid-proof pattern.
